(19) United States
(12) Patent Application Publication
(10) Pub. No.: US 2024/0416683 A1
(43) Pub. Date: Dec. 19, 2024

(54) TIRE WITH A TREAD COMPRISING REINFORCING ELEMENTS

(71) Applicant: COMPAGNIE GENERALE DES ETABLISSEMENTS MICHELIN, Clermont-Ferrand (FR)

(72) Inventor: BENJAMIN GORNARD, Clermont-Ferrand (FR)

(21) Appl. No.: 18/700,462

(22) PCT Filed: Oct. 13, 2022
(86) PCT No.: PCT/FR2022/051924

§ 371 Date: Apr. 11, 2024

(30) Foreign Application Priority Data
Oct. 15, 2021 (FR) 2110968

(51) Int. Cl. B60C 11/00

(52) U.S. Cl. CPC B60C 11/0058; B60C 2011/0025; B60C 2011/0033

(57) ABSTRACT

A tire tread comprises at least one tread pattern block having at least one circumferential reinforcing element made of a composition having a dynamic shear modulus G* at least twice the dynamic shear modulus G* of the composition of the rest of the blocks of the tread. The composition of the at least one circumferential reinforcing element is based on at least one diene elastomer, one reinforcing filler comprising a carbon black exhibiting an STSA specific surface area, measured according to the standard D6556-2016, of greater than or equal to 90 m²/g, one epoxy resin, one amine-comprising curing agent and one crosslinking system.

The present invention relates to tyres, in particular to tyres provided with a tread comprising two distinct elastomeric compositions.

In general terms, a tyre is an object with a geometry exhibiting symmetry of revolution about an axis of rotation. A tyre comprises two beads intended to be mounted on a rim. It also comprises two sidewalls connected to the beads and a crown having a tread intended to come into contact with the ground, the crown having a first side connected to the radially outer end of one of the two sidewalls and a second side connected to the radially outer end of the other one of the two sidewalls.

The makeup of the tyre is usually described by a representation of its constituent components in a meridian plane, which means to say a plane containing the axis of rotation of the tyre. The radial, axial and circumferential directions denote the directions perpendicular to the axis of rotation of the tyre, parallel to the axis of rotation of the tyre and perpendicular to any meridian plane, respectively. In the following text, the expressions “radially”, “axially” and “circumferentially” mean “in a radial direction”, “in the axial direction” and “in a circumferential direction”, respectively, of the tyre. The expressions “radially inner” and “radially outer” mean “closer to” and “further away from the axis of rotation of the tyre, in a radial direction”, respectively. The equatorial plane CP is a plane perpendicular to the axis of revolution of the tyre, positioned axially so as to intersect the surface of the tread substantially midway between the beads. The expressions “axially on the inside” and “axially on the outside” mean “closer to” and “further away from the equatorial plane of the tyre, in the axial direction”, respectively. As is known, tyres for road applications, and very particularly tyres for passenger vehicles, make an essential contribution to the performance of the vehicles in terms of rolling resistance (and thus energy efficiency of the vehicles), of grip, of dynamic response for guiding the vehicles (notably when cornering) and of wear (and thus overall cost of using the vehicles).

To improve the compromise in performance, namely the rolling resistance and the drift thrust response when subjected to stress by the vehicle turning, use is made of a material of low hysteresis that makes it possible to stiffen the tread. Conventionally, stiffnesses are modest so as to not excessively oppose the flattening of the tread of the tyre in the contact patch in which contact is made with the ground. However, the lower the stiffness, the less good the drift thrust response of the tyre is when subjected to stress by the vehicle turning. Currently, even in the variants with the greatest stiffnesses, the dynamic shear modulus G* of the reinforcing or sub-layer materials of the tread of the prior art is generally much less than 8 MPa, even when the best performance in terms of handling is desired. In the present document, it is noted that the dynamic shear modulus G* in question is the dynamic shear modulus G* measured at 23° C. and under an alternating shear stress at a frequency of 10 Hz and at 5% deformation, unless specified otherwise. This descriptor measures the stiffness at low deformation.

To address the improvement of these conflicting performances, tyre manufacturers are developing increasingly complex treads, by proposing for example treads comprising different elastomeric compositions.

An illustrative document that can be cited is WO2016/174100, which describes a tread comprising a rubber tread compound of low hardness, the tread being reinforced by including one or more circumferential reinforcing elements having a triangular shape, as seen in meridian section, said triangle having its vertex oriented radially outwards; these circumferential reinforcing elements being notably stiffer than the rubber compound of the tread. This complex tread makes it possible to obtain a good compromise between the rolling resistance and the dynamic response for guiding the vehicles.

However, there is still a need to further improve the safety of vehicle users by providing them with tyres having a good dynamic response, without adversely affecting the rolling resistance.

The use of elastomeric compositions exhibiting high stiffnesses at low deformation to improve the dynamic response of the tyre does not come without problems for the manufacturers.

This is because it is difficult to obtain elastomeric compositions with high levels of stiffness at low deformation while still keeping the hysteresis at fairly low levels, without significantly degrading the limit properties of these compositions.

One solution for solving this problem is to increase the content of reinforcing fillers in the rubber compositions. However, this solution causes the hysteresis to increase. It is therefore unfavourable for the rolling resistance.

Another solution is to increase the content of crosslinking agent, but it is then observed that the cohesion of the composition decreases. Since the limit properties are greatly affected, the elastomeric composition is less resistant to cracking.

Another solution is to use a “fine” carbon black (i.e. a carbon black having an STSA specific surface area greater than or equal to 70 m²/g) to obtain elastomeric compositions with greater stiffnesses. However, this solution is accompanied by a significant rise in the hysteresis of these compositions. This solution is therefore also unfavourable for the rolling resistance.

Tyre designers are therefore constantly looking for a solution that will make it possible to change the existing compromise on properties by improving at least one property of the tyre without adversely affecting others thereby.

There is therefore still a need to improve the compromise on the stiffness/hysteresis/cohesion performance of an elastomeric composition, notably in order to obtain a tyre exhibiting good dynamic response without adversely affecting its rolling resistance.

The applicant has set itself the objective of meeting this need and providing an elastomeric composition which can be used in circumferential reinforcing elements of a tread.

Thus, the objective of the invention is to achieve a better dynamic drift thrust response under turning stress without adversely affecting the rolling resistance of the tyre, by substituting the material of the circumferential elements of the prior art with a specific rubber composition.

The invention therefore relates to a tyre, having an outer side and an inner side, said tyre comprising a crown reinforcement and a radially outer tread, said tread comprising a plurality of tread pattern blocks oriented at least partially circumferentially and a plurality of grooves extending at least partially circumferentially, each circumferential groove being delimited by an axially internal lateral face, by an axially external lateral face, and by a groove bottom, at least one of said tread pattern blocks having at least one circumferential reinforcing element made of a composition having a dynamic shear modulus G* at least twice the dynamic shear modulus G* of the composition of the rest of the blocks of the tread, the circumferential reinforcing element having an axial width which decreases progressively with increasing radial distance to the outside, said axial width having a maximum value of less than 40% of the axial width of said tread block, characterized in that the composition of said circumferential reinforcing element is based on at least one diene elastomer, one reinforcing filler comprising a carbon black exhibiting an STSA specific surface area, measured according to the standard D6556-2016, of greater than or equal to 90 m²/g, one epoxy resin, one amine-comprising curing agent and one crosslinking system.

In relation to the circumferential reinforcing elements of the prior art, those of the present invention exhibit a better stiffness at low deformation while still preserving low hysteresis properties, by virtue of their specific elastomeric composition. Moreover, they exhibit better cohesion of the material by virtue of the limit properties of the composition, which have been improved.

### I—DEFINITIONS

The expression “composition based on” should be understood as meaning a composition including the mixture and/or the product of the in situ reaction of the various constituents used, some of these constituents being able to react and/or being intended to react with each other, at least partially, during the various phases of manufacture of the composition; the composition thus possibly being in the totally or partially crosslinked state or in the non-crosslinked state.

For the purposes of the present invention, the expression “part by weight per hundred parts by weight of elastomer” (or phr) should be understood as meaning the part by mass per hundred parts by mass of elastomer.

In the present text, unless expressly indicated otherwise, all the percentages (%) indicated are mass percentages (%).

Furthermore, any interval of values denoted by the expression “between a and b” represents the range of values extending from more than a to less than b (i.e. limits a and b excluded), whereas any interval of values denoted by the expression “from a to b” means the range of values extending from a up to b (i.e. including the strict limits a and b).

When reference is made to a “predominant” compound, this is understood to mean, within the meaning of the present invention, that this compound is predominant among the compounds of the same type in the composition, that is to say that it is the one which represents the greatest amount by mass among the compounds of the same type. Thus, for example, a predominant elastomer is the elastomer representing the greatest mass relative to the total mass of the elastomers in the composition. Similarly, a “predominant” filler is the one representing the greatest mass among the fillers of the composition. By way of example, in a system comprising only one elastomer, the latter is predominant for the purposes of the present invention, and in a system comprising two elastomers, the predominant elastomer represents more than half of the mass of the elastomers. On the contrary, a “minor” compound is a compound which does not represent the greatest fraction by mass among the compounds of the same type. Preferably, the term “predominant” means present to more than 50%, preferably more than 60%, 70%, 80%, 90%, and more preferentially the “predominant” compound represents 100%.

The “pattern” of a tread is a more or less complex system of raised elements separated from one another by cut-outs. The raised elements of a tread pattern may be either ribs or tread blocks.

A “rib” is a raised element formed on a tread and extending essentially along the circumferential direction, this element being delimited either by two cut-outs or by a cut-out and an edge of the tread. A rib comprises two lateral walls and a contact face, the latter being intended to come into contact with the road surface during running. This element extends in the circumferential direction and runs all around the tyre.

A “tread block” is a raised element formed on a tread, this element being delimited by one or more rectilinear, curved or circular cut-outs, and possibly by an edge of the tread. A tread block also comprises a contact face, the latter being intended to come into contact with the road surface during running.

The cut-outs may either be grooves or sipes, depending on their width, that is to say the distance between the walls of material that delimit them, and their function during running. The width of a groove is typically at least equal to 2 mm, whereas the width of a sipe is typically at most equal to 2 mm. When the tyre is running, the walls of material of a groove do not come into contact with one another, whereas the walls of material of a sipe at least partially come into contact with one another.

The compounds mentioned in the description may be of fossil origin or may be biobased. In the latter case, they may be partially or totally derived from biomass or may be obtained from renewable starting materials derived from biomass. Obviously, the compounds mentioned may also be derived from the recycling of already-used materials, i.e. they may be partially or totally derived from a recycling process, or obtained from raw materials which are themselves derived from a recycling process. They notably include polymers, plasticizers, fillers, etc.

All the values for glass transition temperature “Tg” described in the present document are measured in a known way by DSC (Differential Scanning calorimetry) according to the standard ASTM D3418 (1999).

### II—BRIEF DESCRIPTION OF THE FIGURES

FIG. 1 schematically shows a partial meridian section through a tyre according to one embodiment of the invention.

FIG. 2 schematically shows a partial meridian section through a tyre according to another embodiment of the invention.

FIG. 3 schematically shows a partial meridian section through a tyre according to another embodiment of the invention.

FIG. 4 schematically shows a partial meridian section through a tyre according to another embodiment of the invention.

FIG. 5 schematically shows a partial meridian section through a tyre according to another embodiment of the invention.

FIG. 6 schematically shows a partial meridian section through a tyre according to another embodiment of the invention.

FIG. 7 schematically shows a partial meridian section through a tyre according to another embodiment of the invention.

FIG. 8 shows a meridian section through embodiment variants of a circumferential reinforcing element which can be used within the scope of the invention.

### III—DESCRIPTION OF THE INVENTION

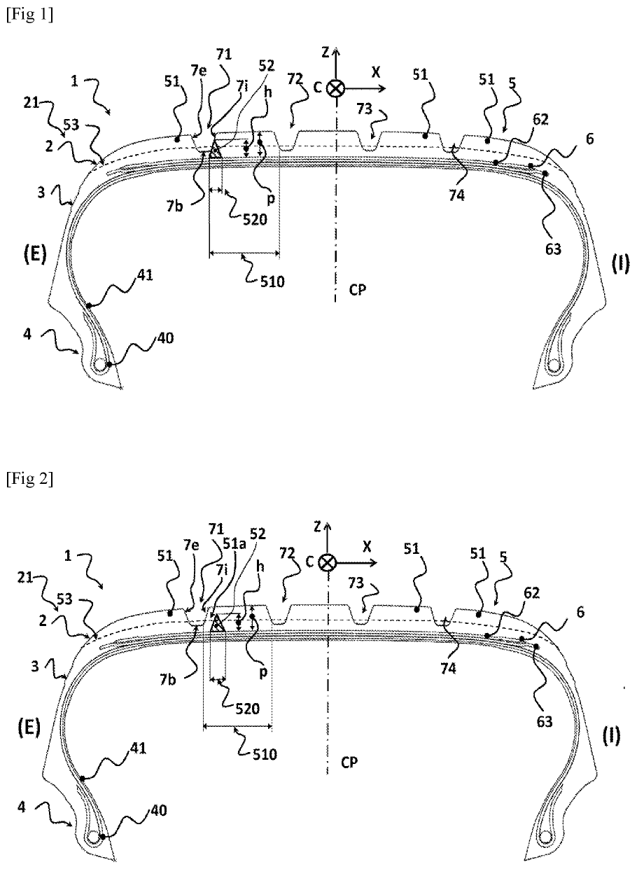

FIG. 1 shows a tyre 1, having an outer side E and an inner side I, the tyre comprising a crown 2 and two sidewalls 3, each sidewall being connected to a bead 4. The crown 2 is connected on each side to the radially outer end of each of the two sidewalls. The crown 2 has a tread 5. FIG. 1 shows an equatorial plane CP, which is perpendicular to the axis of rotation of the tyre, situated mid-way between the two beads 4 (mounted on the rim) and passing through the middle of the belt reinforcement; FIG. 1 also indicates, by way of arrows placed just above the tread 5, on the equatorial plane CP, the axial direction X, circumferential direction C and radial direction Z.

By convention, the outer side E of the tyre is the axially external part of the tyre that is intended to be visible from outside the vehicle once it is mounted and the inner side I is the axially external part of the tyre that is oriented towards the chassis of the vehicle once it is mounted.

Each bead has a bead wire 40. A carcass ply 41 is wrapped around each bead wire 40. The carcass ply 41 is radial and, in a manner known per se, is made up of cords; in this implementation, they are textile cords; these cords are placed substantially parallel to one another and extending from one bead to the other in such a way that they form an angle of between 80° and 90° with the equatorial plane CP.

The tread 5 comprises a plurality of tread pattern blocks 51. Two axially adjacent tread pattern blocks 51 are separated by a groove 71, 72, 73, 74 extending at least partially circumferentially. Each circumferential groove 71, 72, 73, 74 is delimited by an axially internal lateral face 7i, by an axially external lateral face 7e and by a groove bottom 7b. Advantageously, the tread comprises at least three, preferably three to five tread blocks, tread pattern blocks 51 and consequently at least two, preferably two to four, grooves 71, 72, 73, 74.

The crown 2 comprises a crown reinforcement 6 comprising two crown plies 62, 63; the crown 2 also comprises a carcass ply 41. In a very conventional way, the belt plies 62, 63 are formed by metal cords placed parallel to one another. In a well-known manner, the reinforcing elements that the cords of the carcass ply 41 and the cords of the belt plies 62, 63 form are oriented in at least three different directions so as to form a triangulation. The crown reinforcement 6 could also comprise a hooping ply made up of hoop reinforcers formed of organic or aromatic polyamide fibres forming an angle with the circumferential direction at most equal to 5°. The crown reinforcement 6 could also comprise other reinforcers, oriented at an angle closer to 90°; the makeup of the crown reinforcement does not form part of the invention and, in this document, when reference is made to the radially outer surface of the belt reinforcement, that means the radially outermost level of the radially outermost layer of reinforcing threads or cords, including the fine layer of skim compound skim-coating the reinforcing threads or cords if such a layer is present.

One of the tread pattern blocks 51 also comprises a circumferential reinforcing element 52. This circumferential reinforcing element 52 is made of a rubber compound having a stiffness at least twice the stiffness of the rubber compound of the rest of the blocks of the tread. Advantageously, the composition of the rest of the tread blocks of the tread has a dynamic shear modulus G*, measured at 60° C. at 10 Hz and under an alternating shear stress of 0.7 MPa, of less than or equal to 2.5 MPa, preferably less than 1.3 MPa, more preferably still less than 1.1 MPa. An example of a composition of the rest of the tread that can be cited is a composition comprising 100 phr of an SBR (with 27% styrene, and, as a percentage of the butadiene portion of the copolymer, 5% 1,2-butadiene, 15% cis-1,4-butadiene, 80% trans-1,4-butadiene; Tg −48° C.), 100 phr of Zeosil 1165MP silica from Solvay, 9 phr of TESPT SI69 silane from Evonik, 20 phr of TDAE Flexon 630 oil from Shell, 50 phr of Escorez 2173 resin from Exxon, 5 phr of carbon black and 12 phr of additives (vulcanization and protection system) that are conventionally used in tread compositions.

The composition of the circumferential reinforcing element 52 will be described in more detail below.

The circumferential reinforcing element 52 extends radially from the radially outer surface of said crown reinforcement 6 towards the surface of said tread with an axial width which decreases progressively with increasing radial proximity to the outside, and at most over a height “h” corresponding to 75% of the thickness “p” of the tread. The thickness “p” of the tread is measured radially between the radially outer end of the crown reinforcement 6 and the surface of the tread 5 that is in contact with the ground.

The circumferential reinforcing element 52 has an axial width that has a maximum value 520, at the junction with the crown reinforcement 6, that is less than 30% of the axial width 510 of said tread block, measured where the lateral walls of the groove meet the groove bottom. Reference will be made in particular to FIG. 1.

Owing to its stiffness properties, the circumferential reinforcing element 52 counters the rocking and shearing of the rib formed by the tread block 51 provided with such a circumferential reinforcing element 52, without causing any unwanted axially oriented thrust. This makes it possible to preserve a considerable surface area on the tread that is in contact with the ground when running, and to limit overpressures on the leading edge of the rib or the tread pattern blocks and thus to limit the heating and the rapid wear of the leading edge of the rib. The presence of the reinforcing element makes it possible to stiffen the tread pattern blocks in terms of axial shear, and ultimately makes it possible to improve the cornering stiffness of the tyre and therefore the road holding of the vehicle. Thus, the presence of the circumferential reinforcing element 52 makes it possible to fully utilize the grip capabilities of a rubber tread compound of very low stiffness (that is to say, rubber compounds of the tread generally having a dynamic shear modulus G*, measured at 60° C. at 10 Hz and under an alternating shear stress of 0.7 MPa, of less than or equal to 2.5 MPa, preferably less than 1.3 MPa, and more preferably still less than 1.1 MPa).

A person skilled in the art, who is a tyre designer, should be able to adapt the number and the position of the circumferential reinforcing elements in order to obtain optimum resistance to the rocking and shearing of the ribs and tread pattern elements.

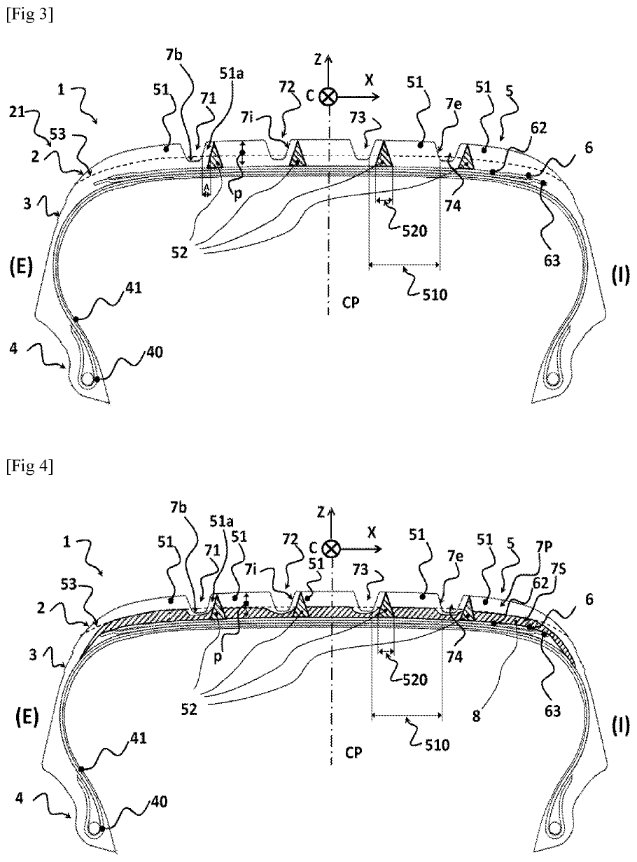

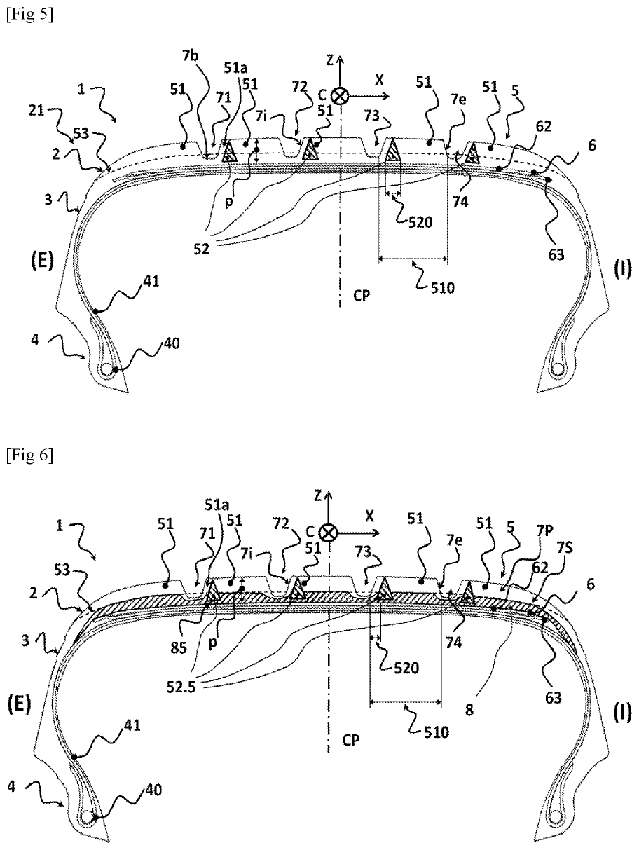

For preference, most of the blocks or all of the blocks 51 are provided with at least one circumferential reinforcing element 52 as shown in FIGS. 3 to 7. Particularly advantageously, the circumferential reinforcing element 52 at least partially forms the axially internal lateral face 7i or a radially external lateral face 7e of said at least one of said tread pattern blocks 51. In other words, advantageously, at least part of the radially internal or external face of at least one groove 71, 72, 73, 74 is made up of a circumferential reinforcing element 52.

FIGS. 2 to 6 illustrate implementation examples of the invention in which a covering 51a, made of the same rubber compound as the rest of the tread blocks, is interposed axially between a groove 71 and a circumferential reinforcing element 52. By consulting FIG. 3 in particular, it can be seen that said covering 51a extends axially over an axial width “A” comprised preferentially between 4% and 15% of the axial width 510 of said tread block; the covering 51a and the axial width A are not identified at all points in FIG. 3 where there is a circumferential reinforcer 52 present, in order not to overload this figure, just as this aspect is not systematically identified by these references in the other figures, but let us emphasise the generic nature of this aspect, which is valid for all the embodiments of the invention presented in FIGS. 2 to 6.

As for the radial height of the circumferential reinforcing element 52, in FIGS. 1 and 2 it can be seen that this cannot advantageously be less than 50% of the thickness “p” of the tread, said axial width having a zero value at the highest radial position, forming a kind of point embedded in the thickness of the circumferential reinforcer 52. This already makes it possible to obtain a significant reinforcing effect, while at the same time leaving only the lowest-stiffness rubber compound in contact with the roadway until the tyre becomes part-worn. Advantageously, the circumferential reinforcing element 52 extends radially over a height “h” corresponding to 50% to 100%, preferably 50% to 75%, of the thickness “p” of the tread 5. However, as in FIGS. 3, 4 and 5, the radial height of the circumferential reinforcing element 52 may correspond to 100% of the thickness “p” of the tread, said axial width having a zero value at the radial position corresponding to the surface in contact with the ground when the tyre is new; of course, a person skilled in the art will easily be able to adjust the tyre performance by adopting, for the radial height, all the intermediate values that fall between the values indicated above.

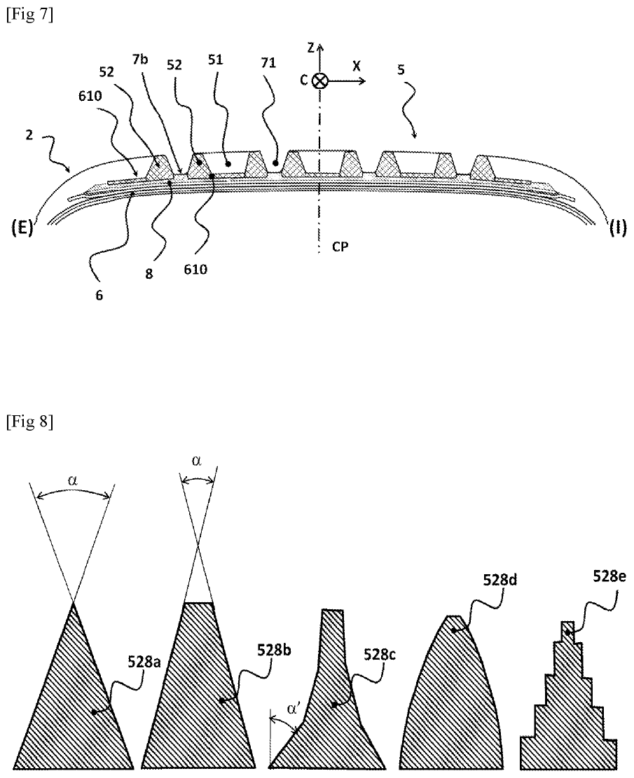

FIGS. 4, 6 and 7, illustrate implementation examples of the invention in which the tread 2 comprises a radially inner layer 8. This one radially inner layer 8 of the tread may be interposed between the crown reinforcement 6 and said tread blocks 51. It is possible for it not to be interposed between the crown reinforcement 6 and the circumferential reinforcing elements 52, as illustrated in FIG. 4, or else it may be interposed between the crown reinforcement 6 and said tread blocks 51 and also between the crown reinforcement 6 and each circumferential reinforcing element 52 of said tread blocks 51, as illustrated in FIGS. 6 and 7.. As a result, the radially inner surface of the circumferential reinforcing element 52 may be placed in contact with the radially outer surface of the crown reinforcement 6. However, the circumferential reinforcing element 52 is particularly advantageously situated within the tread 5, that is to say not in contact with the radially outer surface of the crown reinforcement 6, for example in contact with the radially outer surface or within a radially inner layer (8) of the tread.

The shape of the circumferential reinforcing elements presented in FIGS. 1 to 7 is triangular, but this shape may vary and the lateral walls may be concave, convex or in the form of a staircase, notably without departing from the scope of this invention. FIG. 8 in which, for reference, a circumferential reinforcing element 528a seen in meridional section has the shape of a triangle as used in all the earlier illustrations, the lateral walls, seen in meridional section, therefore being straight lines. In a variant formed by the circumferential reinforcing element 528b, the meridional section thereof is a trapezium, the lateral walls seen in meridional section also being straight lines; the radially outer limit of this circumferential reinforcing element 528b is also a straight line and, for example, may lie flush with the surface of the tread. In a variant formed by the circumferential reinforcing element 528c, the lateral walls seen in meridional section are straight-line segments, the angle α′ formed by each of these segments with the radial direction varying from one segment to the next (decreasing with increasing radial proximity to the outside in the figure). In a variant formed by the circumferential reinforcing element 528d, the lateral walls seen in meridional section are curved, convex; they could be concave. In a variant formed by the circumferential reinforcing element 528e, the lateral walls seen in meridional section form staircases. These variations in the shape of the meridional section can be used with all the embodiments described above. The shapes of the circumferential reinforcing elements 52 are, non-limitingly, preferably axially symmetric in order to limit unwanted thrust when flattening, but the shapes of the reinforcer may also be asymmetric so as to combat said unwanted forces. Furthermore, advantageously, the angle α formed by the two lateral walls of the one or more circumferential reinforcing elements is between 10 and 50 degrees, preferably between 35 and 45 degrees. If the lateral walls of the one or more circumferential reinforcing elements are not straight lines, the angle α is considered with respect to the imaginary straight line from the axial ends of the base of the circumferential reinforcing element to the end (or, as the case may be, to the adjacent axial ends) of the crown of the circumferential reinforcing element.

According to a particularly preferred embodiment of the invention, presented in FIG. 7, it is also possible to see an extended base 610 extending axially from a circumferential reinforcing element 52. In this figure, the extended base 610 is placed radially on a radially inner layer 8 and radially on the inside of the tread 5. However, the extended base 610 may also be situated on the radially outer surface of the crown reinforcement 6. Axially on either side of each of the grooves 71, 72, 73, 74, there is a circumferential reinforcing element 52 in the form of a wedge (seen in meridian section). This circumferential reinforcing element 52 extends radially from the radially outer surface of the radially inner layer 8 of the tread towards the outside of the tread 5 to a radial height greater than 75% of the radial thickness of the tread. It will be noted that the extended base 610 preferably extends axially from one circumferential reinforcing element 52 to the next for those tread pattern blocks that are comprised between two grooves 71, 72, 73, 74, and extends axially from one circumferential reinforcing element 52 towards the shoulder 2. Also preferably, the extended base 610 substantially totally covers a radially inner layer 8 of the tread, for the tread pattern blocks that are situated at the axial ends of the tread.

Advantageously, the tyre comprises at least two circumferential reinforcing elements 52, and an extended base 610 placed radially on a radially inner layer 8 of the tread that is interposed between the crown reinforcement 6 and said tread blocks 51, and axially covering the radially inner layer 8 of the tread between two circumferential reinforcing elements 52. The extended base 610 preferably connects two circumferential reinforcing elements 52 outside the grooves 71, 72, 73, 74. However, it could also connect two circumferential reinforcing elements 52 by passing underneath the grooves 71, 72, 73, 74.

Furthermore, the extended base 610 may also be placed radially on a radially inner layer 8 of the tread that is interposed between the crown reinforcement 6 and said tread blocks 51, and axially covering the radially inner layer 8 of the tread between a circumferential reinforcing element 52 and the shoulder 2.

Advantageously, each circumferential reinforcing element 52 is made of the same composition. Moreover, when the tread comprises an extended base 610, the extended base 610 is advantageously made of the same composition as the circumferential reinforcing elements 52, thereby making it possible to extrude them in one and the same operation with the extended base 610.

According to the invention, the composition of the circumferential reinforcing element 52 is based on (i) at least one diene elastomer, (ii) at least one reinforcing filler comprising a carbon black exhibiting an STSA specific surface area, measured according to the standard ASTM D6556-2016, of greater than or equal to 90 m²/g, (iii) at least one epoxy resin, at least one amine-comprising curing agent and (iv) at least one crosslinking system. The composition of the circumferential reinforcing element 52 comprises at least one diene elastomer. It can thus contain just one diene elastomer or a mixture of several diene elastomers.

The term “diene elastomer” (or, without distinction, rubber), whether natural or synthetic, should be understood, in a known manner, as meaning an elastomer consisting, at least partially (i.e., a homopolymer or a copolymer) of diene monomer units (monomers bearing two conjugated or non-conjugated carbon-carbon double bonds).

These diene elastomers may be classified into two categories: “essentially unsaturated” or “essentially saturated”. “Essentially unsaturated” is generally understood to mean a diene elastomer derived at least in part from conjugated diene monomers having a content of units of diene origin (conjugated dienes) which is greater than 15% (mol %); thus, diene elastomers such as butyl rubbers or copolymers of dienes and of α-olefins of EPDM type do not fall under the preceding definition and may especially be termed “essentially saturated” diene elastomers (low or very low content, always less than 15%, of units of diene origin). The diene elastomers included in the composition according to the invention are preferentially essentially unsaturated.

The term “diene elastomer that may be used in the compositions in accordance with the invention” particularly means:
(a) any homopolymer of a conjugated or non-conjugated diene monomer having from 4 to 18 carbon atoms;
(b) any copolymer of a conjugated or non-conjugated diene having from 4 to 18 carbon atoms and of at least one other monomer.

The other monomer can be ethylene, an olefin or a conjugated or non-conjugated diene. Suitable conjugated dienes are conjugated dienes having from 4 to 12 carbon atoms, in particular 1,3-dienes, such as especially 1,3-butadiene and isoprene.

Suitable olefins are vinylaromatic compounds having from 8 to 20 carbon atoms and aliphatic α-monoolefins having from 3 to 12 carbon atoms.

Suitable vinylaromatic compounds include, for example, styrene, ortho-, meta- or para-methylstyrene, the “vinyltoluene” commercial mixture or para-(tert-butyl) styrene. Suitable aliphatic α-monoolefins are especially acyclic aliphatic α-monoolefins having from 3 to 18 carbon atoms.

Preferentially, the diene elastomer is selected from the group consisting of polybutadienes (BRs), natural rubber (NR), synthetic polyisoprenes (IRs), butadiene copolymers, isoprene copolymers and the mixtures of these elastomers. The butadiene copolymers are particularly selected from the group consisting of butadiene/styrene copolymers (SBRs). Preferably, the diene elastomer is an isoprene elastomer.

The term “isoprene elastomer” is understood, in a known manner, to mean an isoprene homopolymer or copolymer, in other words a diene elastomer selected from the group consisting of natural rubber (NR), synthetic polyisoprenes (IRs), the various isoprene copolymers, and the mixtures of these elastomers. Mention will in particular be made, among the isoprene copolymers, of isobutene/isoprene (butyl rubber—IIR), isoprene/styrene (SIR), isoprene/butadiene (BIR) or isoprene/butadiene/styrene (SBIR) copolymers. This isoprene elastomer is preferably selected from the group consisting of natural rubber, synthetic cis-1,4-polyisoprenes, and mixtures of these. Of these synthetic polyisoprenes, use is preferably made of polyisoprenes that have a content (mol %) of cis-1,4 bonds greater than 90%, more preferentially still greater than 98%. Preferably and according to any one of the arrangements of the present document, the diene elastomer is natural rubber.

Preferentially, the content of diene elastomer, preferably the content of isoprene elastomer, preferably the content of natural rubber, is within a range from 50 to 100 phr, more preferentially from 60 to 100 phr, more preferentially from 70 to 100 phr, more preferentially still from 80 to 100 phr and very preferentially from 90 to 100 phr. In particular, the content of diene elastomer, preferably of isoprene elastomer, more preferably of natural rubber, is very preferentially 100 phr.

Whether it contains just one diene elastomer or a mixture of several diene elastomers, the rubber composition according to the invention can also contain, in a minor way, any type of synthetic elastomer other than a diene elastomer, indeed even polymers other than elastomers, for example thermoplastic polymers. Preferably, the rubber composition according to the invention does not contain a synthetic elastomer other than a diene elastomer or a polymer other than elastomers or contains less than 10 phr, preferably less than 5 phr, thereof.

The composition of the circumferential reinforcing element 52 in accordance with the invention also comprises a reinforcing filler comprising a carbon black exhibiting an STSA specific surface area, measured according to the standard ASTM D6556-2016, of greater than or equal to 90 m²/g.

The STSA specific surface area of the carbon black that can be used in the composition of the circumferential reinforcing element 52 is preferentially within a range from 95 to 250 m²/g, more preferentially still within a range from 100 to 190 m²/g, more preferentially within a range from 110 to 150 m²/g.

The carbon black that can be used in the composition of the circumferential reinforcing element 52 may preferentially have the additional feature of a COAN number greater than or equal to 75 ml/100 g, the COAN number being measured according to the standard ASTM D3493-2018. More preferentially still, the COAN number is within a range from 80 to 140 ml/100 g, more preferentially still from 90 to 130 ml/100 g.

The carbon black that can be used in the composition of the circumferential reinforcing element 52 preferentially exhibits an STSA specific surface area of greater than or equal to 90 m²/g and a COAN number of greater than or equal to 75 ml/100 g. More preferentially still, the carbon black exhibits an STSA specific surface area within a range from 95 to 250 m²/g and a COAN number from 90 to 130 ml/100 g.

The carbon black that can be used in the composition of the circumferential reinforcing element 52 preferentially has an iodine adsorption number, measured according to the standard ASTM D1510-2017, of greater than or equal to 100 g/kg.

More preferentially still, the carbon black that can be used in the composition of the circumferential reinforcing element 52 has an iodine adsorption number, within a range from 105 to 200 g/kg, more preferentially from 115 to 170 g/kg.

More preferentially still, the carbon black exhibits an STSA specific surface area within a range from 95 to 250 m²/g and a COAN number from 90 to 130 ml/100 g and an iodine adsorption number within a range from 115 to 170 g/kg.

The carbon blacks that can be used in the composition of the circumferential reinforcing element 52 can be obtained by any carbon black manufacturing method and are commercially available from suppliers such as Cabot, Orion, etc.

It will be noted that the carbon blacks could be, for example, already incorporated in the diene elastomer, such as an isoprene elastomer, preferably natural rubber, in the form of a masterbatch produced by a dry or liquid process as described in documents WO97/36724A2 and WO99/16600A1.

The carbon black described above advantageously makes up more than 50% by mass of the mass of the reinforcing filler; in other words, the carbon black described above is predominant in the reinforcing filler. The carbon black described above preferentially makes up more than 70% by mass, more preferentially still more than 90% by mass, of the reinforcing filler, and even more preferentially represents 100% by mass of the reinforcing filler.

According to one variant of the invention, the reinforcing filler may comprise, in addition to the carbon black cited above, an inorganic reinforcing filler, more preferentially a silica.

The term “reinforcing inorganic filler” should be understood, in the present application and by definition, to mean any inorganic or mineral filler (irrespective of its colour and its origin-whether natural or synthetic), also referred to as “white filler”, “clear filler” or even “non-black filler”, which, by contrast to carbon black, is capable of reinforcing, by itself alone, without any means other than an intermediate coupling agent, a rubber composition intended for the manufacture of tyres, in other words capable of replacing, in its reinforcing role, a conventional tyre-grade carbon black; such a filler is generally characterized, in a known way, by the presence of hydroxyl (—OH) groups at its surface. Mineral fillers of the siliceous type, in particular silica (SiO₂), or of the aluminous type, in particular alumina (Al₂O₃), are suitable in particular as reinforcing inorganic fillers. The silica used can be any reinforcing silica known to a person skilled in the art, in particular any precipitated or fumed silica exhibiting a BET specific surface area and also a CTAB specific surface area which are both less than 450 m²/g, preferably from 30 to 400 m²/g. Highly dispersible precipitated silicas (“HDSs”) that can be mentioned are, for example, the Ultrasil 7000 and Ultrasil 7005 silicas from Degussa, the Zeosil 1165MP, 1135MP and 1115MP silicas from Rhodia, the Hi-Sil EZ150G silica from PPG, the Zeopol 8715, 8745 and 8755 silicas from Huber or the silicas having a high specific surface area as described in the application WO 03/16837.

The BET specific surface area of the silica is determined in a known way by gas adsorption using the Brunauer-Emmett-Teller method described in “The Journal of the American Chemical Society”, vol. 60, page 309, February 1938, more specifically according to the French standard NF ISO 9277 of December 1996 (multipoint (5 point) volumetric method—gas: nitrogen—degassing: 1 hour at 160° C.—relative pressure p/p₀ range: 0.05 to 0.17). The CTAB specific surface area of the silica is determined according to the French standard NF T 45-007 of November 1987 (method B).

Mineral fillers of the aluminous type, in particular alumina (Al₂O₃) or aluminium (oxide) hydroxides, or else reinforcing titanium oxides, for example described in U.S. Pat. Nos. 6,610,261 and 6,747,087, are also suitable as reinforcing inorganic fillers.

The physical state in which the reinforcing inorganic filler is provided is not important, whether it is in the form of a powder, microbeads, granules, beads or any other suitable densified form. Of course, the term “reinforcing inorganic filler” is also understood to mean mixtures of different reinforcing inorganic fillers, in particular of highly dispersible siliceous and/or aluminous fillers.

A person skilled in the art will understand that use might be made, as filler equivalent to the reinforcing inorganic filler described in the present section, of a reinforcing filler of another nature, in particular organic nature, provided that this reinforcing filler is covered with an inorganic layer, such as silica, or else comprises, at its surface, functional sites, in particular hydroxyl sites, making it possible to establish the bond between the filler and the elastomer in the presence or absence of a covering or coupling agent.

In order to couple the reinforcing inorganic filler to the diene elastomer, use may be made, in a well-known manner, of an at least bifunctional coupling agent (or bonding agent) intended to provide a satisfactory connection, of chemical and/or physical nature, between the inorganic filler (surface of its particles) and the diene elastomer. Use is made in particular of organosilanes or polyorganosiloxanes which are at least bifunctional. The term “bifunctional” means a compound having a first functional group that is capable of interacting with the inorganic filler and a second functional group that is capable of interacting with the diene elastomer. For example, such a bifunctional compound may comprise a first functional group comprising a silicon atom, said first functional group being capable of interacting with the hydroxyl groups of an inorganic filler, and a second functional group comprising a sulfur atom, said second functional group being capable of interacting with the diene elastomer.

Preferentially, the organosilanes are selected from the group consisting of (symmetrical or asymmetrical) organosilane polysulfides, such as bis(3-triethoxysilylpropyl) tetrasulfide, TESPT for short, sold under the name Si69 by Evonik, or bis(3-triethoxysilylpropyl) disulfide, TESPD for short, sold under the name Si75 by Evonik, polyorganosiloxanes, mercaptosilanes, blocked mercaptosilanes, such as S-(3-(triethoxysilyl) propyl) octanethioate, sold by Momentive under the name NXT Silane. More preferentially, the organosilane is an organosilane polysulfide.

The content of coupling agent is preferentially less than 12 phr, it being understood that it is generally desirable to use as little as possible of it. Typically, when a reinforcing inorganic filler is present, the content of coupling agent represents from 0.5% to 15% by weight with respect to the amount of inorganic filler. Its content is preferentially within a range extending from 0.5 to 15 phr. This content is easily adjusted by a person skilled in the art according to the content of inorganic filler used in the composition.

Advantageously, the content of reinforcing filler, in the composition of said circumferential reinforcing element 52, is within a range from 20 to 200 phr, preferably from 25 to 150 phr, more preferentially from 30 to 100 phr.

The epoxy resins that can be used in the composition of said circumferential reinforcing element 52 include all the polyepoxide compounds. The epoxy resin is preferentially selected from the group consisting of aromatic epoxy resins, alicyclic epoxides, aliphatic epoxides, and mixtures of these. For example, the aromatic epoxy resin can be an amine-aromatic epoxy resin. The epoxy resins are preferentially epoxy novolac resins, that is to say epoxy resins obtained by acid catalysis, in contrast to resol resins, which are obtained by basic catalysis.

In particular, preference is given, among aromatic epoxy resins, to the epoxy resins selected from the group consisting of 2,2-bis[4-(glycidyloxy)phenyl]propane, poly[(o-cresyl glycidyl ether)-co-formaldehyde], poly[(phenyl glycidyl ether)-co-formaldehyde], poly[(phenyl glycidyl ether)-co-(hydroxybenzaldehyde glycidyl ether)], aromatic amine epoxy resins and the mixtures of these compounds, and preferably the epoxy resins selected from the group consisting of poly[(o-cresyl glycidyl ether)-co-formaldehyde and poly[(phenyl glycidyl ether)-co-(hydroxybenzaldehyde glycidyl ether)] and the mixture thereof.

The epoxy resin is more preferably selected from the group consisting of poly[(o-cresyl glycidyl ether)-co-formaldehyde], poly[(phenyl glycidyl ether)-co-formaldehyde], aromatic amine epoxy resins and the mixtures of these compounds.

Examples of commercially available epoxy resins which can be used in the context of the present invention that can be mentioned are, for example, the DEN 439 epoxy resin from Uniqema, the tris(4-hydroxyphenyl) methane triglycidyl ether epoxy resin from Sigma-Aldrich, the Araldite ECN 1299 epoxy cresol novolac resin from Huntsman or the Araldite EPN 1138 epoxy phenol novolac resin from Huntsman.

The content of epoxy resin in the composition of said circumferential reinforcing element 52 is within a range from 1 to 30 phr. In view of the amine-comprising curing agent used in the context of the present invention, below the minimum content of resin indicated, the targeted technical effect is insufficient whereas, above the maximum indicated, risks arise of an excessive increase in the stiffness and an excessive adverse effect on the hysteresis and the limit properties of the material. For all these reasons, the content of epoxy resin is preferentially within a range from 5 to 25 phr. More preferably still, the content of epoxy resin in the composition of said circumferential reinforcing element 52 is within a range from 8 to 20 phr.

The combination of the specific carbon black as described above, including its preferred forms, with the specific epoxy resin as described above, including its preferred forms, makes it possible entirely unexpectedly to improve the stiffness at low of the elastomeric composition containing them while still preserving properties of low hysteresis (which is thus favourable to the rolling resistance). Advantageously and surprisingly, by virtue of this combination the elastomeric composition also exhibits better cohesion and is thus more resistant to cracking.

The composition of the circumferential reinforcing element 52 in accordance with the invention also comprises an amine-comprising curing agent. This amine-comprising curing agent combined with the resin makes it possible to crosslink the resin.

It is possible to use any known amine-comprising curing agent for the composition of the circumferential reinforcing element 52.

Known curing agents are (poly)amine-comprising compounds including polyphenol compounds and cationic photoinitiators, notably dicyandiamides, hydrazides, imidazole compounds, sulfonium salts, onium salts, ketimines, acid anhydrides, for example 4,4′-(4,4′-isopropylidenediphenoxy)bis(phthalic anhydride) polyanhydride, and pyromellitic dianhydride.

In particular, polyamines are preferred. The amine-comprising curing agent is preferentially selected from the group consisting of aliphatic polyamines, alicyclic polyamines, aromatic polyamines, and mixtures of these. The polyamine compounds include aliphatic polyamines, such as ethylenediamine, diethylenetriamine, and triethylenetetramine, in particular 1,8-diaminooctane, alicyclic polyamines such as 1,3-bis(aminomethyl)cyclohexane, aliphatic amines having an aromatic ring such as m-xylylenediamine, p-xylylenediamine, and aromatic polyamines, m-phenylenediamine, 2,2-bis(4-aminophenyl) propane, diaminodiphenylmethane, diaminodiphenyl sulfone, 2,2-bis(4-aminophenyl)-p-diisopropyl benzene, in particular 3,3′-diaminobenzidine.

More preferentially still, the curing agent is an aromatic polyamine, preferably an aromatic polyamine comprising at least two primary amine functions situated on at least one (that is to say one or more) aromatic ring with 6 carbon atoms.

Aromatic polyamine curing agents comprising at least two primary amine functions situated on at least one aromatic ring with 6 carbon atoms are well known and described on pages 13 to 19 of the application WO2018002538.

The amine-comprising curing agent is preferentially selected from the group consisting of m-xylylenediamine, p-xylylenediamine, 1,3-bis(aminomethyl)cyclohexane, 1,8-diaminooctane, 3,3′-diaminobenzidine, 4,4′-methylenebis[2,6-diethylaniline], methylenebis(3-chloro-2,6-diethylaniline), 1-methyl-3,5-diethyl-2,6-diaminobenzene, 3,5-diethyltoluene-2,4-diamine, 2-methyl-4,6-bis(methylthio)-1,3-benzenediamine, 4-methyl-2,6-bis(methylthio)-1,3-benzenediamine, and mixtures of these compounds.

More preferentially still, the amine-comprising curing agent is selected from the group consisting of 4,4′-methylenebis[2,6-diethylaniline], methylenebis(3-chloro-2,6-diethylaniline), 1-methyl-3,5-diethyl-2,6-diaminobenzene, 3,5-diethyltoluene-2,4-diamine, 2-methyl-4,6-bis(methylthio)-1,3-benzenediamine, 4-methyl-2,6-bis(methylthio)-1,3-benzenediamine, and the mixtures of these compounds.

The amount of curing agent is within a range from 1 to 15 phr, more preferentially within a range from 1 to 10 phr, more preferentially still from 2 to 8 phr; below the minimum indicated, the targeted technical effect has proved to be insufficient whereas, above the maximum indicated, risks arise of adversely affecting the processing in the raw state of the compositions.

More preferentially still, the epoxy resin is selected from the group consisting of from the group consisting of poly[(o-cresyl glycidyl ether)-co-formaldehyde], poly[(phenyl glycidyl ether)-co-formaldehyde] and mixtures of these, and the amine-comprising curing agent is selected from the group consisting of 4,4′-methylenebis[2,6-diethylaniline], methylenebis(3-chloro-2,6-diethylaniline), 1-methyl-3,5-diethyl-2,6-diaminobenzene, 3,5-diethyltoluene-2,4-diamine, 2-methyl-4,6-bis(methylthio)-1,3-benzenediamine, 4-methyl-2,6-bis(methylthio)-1,3-benzenediamine, and the mixtures of these compounds.

The crosslinking system of said circumferential reinforcing element 52 may be any type of system known to those skilled in the art in the field of rubber compositions for tyres. It may notably be based on sulfur and/or on peroxide and/or on bismaleimides.

Preferentially, the crosslinking system is based on sulfur; it is then called a vulcanization system. The sulfur can be provided in any form, in particular in the form of molecular sulfur and/or of a sulfur-donating agent. At least one vulcanization accelerator is also preferentially present, and, optionally, also preferentially, use may be made of various known vulcanization activators, such as zinc oxide, stearic acid or an equivalent compound, such as stearic acid salts, and salts of transition metals, guanidine derivatives (in particular diphenylguanidine), or else known vulcanization retarders.

Sulfur is used, in the composition of said circumferential reinforcing element 52, in a preferential content of between 0.3 phr and 10 phr, more preferentially between 0.3 and 5 phr. The primary vulcanization accelerator is used, in the composition of said circumferential reinforcing element 52, in a preferential content of between 0.5 and 10 phr, more preferentially between 0.5 and 5 phr.

The accelerator used may be any compound that is capable of acting as a vulcanization accelerator for the diene elastomers in the presence of sulfur, notably accelerators of the thiazole type, and also derivatives thereof, or accelerators of the sulfenamide, thiuram, dithiocarbamate, dithiophosphate, thiourea and xanthate types. Examples of such accelerators that can be mentioned are notably the following compounds: 2-mercaptobenzothiazyl disulfide (MBTS for short), N-cyclohexyl-2-benzothiazolesulfenamide (CBS), N,N-dicyclohexyl-2-benzothiazolesulfenamide (DCBS), N-(tert-butyl)-2-benzothiazolesulfenamide (TBBS), N-(tert-butyl)-2-benzothiazolesulfenimide (TBSI), tetrabenzylthiuram disulfide (TBZTD), zinc dibenzyldithiocarbamate (ZBEC), and the mixtures of these compounds.

Although not necessary for the implementation of the invention, the composition of said circumferential reinforcing element 52 may comprise a plasticizer.

In a manner known to those skilled in the art of rubber compositions for tyres, this plasticizer is preferably selected from hydrocarbon resins having a high glass transition temperature (Tg), that is to say having a Tg greater than 20° C., preferably greater than 30° C., hydrocarbon resins having a low Tg, that is to say having a Tg within a range from −40° C. to 20° C., plasticizing oils, and mixtures of these. Preferably, the plasticizer is selected from hydrocarbon resins having a high Tg, plasticizing oils and mixtures thereof.

The composition of said circumferential reinforcing element 52 preferably does not comprise any plasticizing hydrocarbon resin (having a high or low Tg) or comprises it to less than 19 phr, preferably less than 15 phr, more preferably still less than 10 phr. More preferably still, the composition of said circumferential reinforcing element 52 does not comprise any plasticizing hydrocarbon resin at all.

Also advantageously, the composition of said circumferential reinforcing element 52 does not comprise any plasticizing oil that is liquid at 20° C., or comprises it to less than 33 phr, preferably less than 15 phr.

However, the use of plasticizing oil can prove useful for facilitating the preparation and implementation of the circumferential reinforcing element 52. Thus, preferably, where the composition of said circumferential reinforcing element (52) comprises from 0 to 25 phr, preferably from 5 to less than 15 phr, of at least one plasticizing oil that is liquid at 20° C.

Any plasticizing oil that is liquid at 20° C., whether it is aromatic or non-aromatic in nature, and is known for its plasticizing properties towards elastomers, can be used. At room temperature (20° C.), these oils, which are more or less viscous, are liquids (that is to say, as a reminder, substances which have the ability to take on the shape of their container), as opposed, notably, to hydrocarbon resins having a high Tg, which are by nature solids at room temperature. The liquid plasticizing oil advantageously has a Tg less than −20° C., preferably less than −40° C.

Plasticizing oils chosen from the group consisting of naphthenic oils (of high or low viscosity, notably hydrogenated or non-hydrogenated), paraffinic oils, MES (Medium Extracted Solvate) oils, TDAE (Treated Distillate Aromatic Extract) oils, RAE (Residual Aromatic Extract) oils, TRAE (Treated Residual Aromatic Extract) oils, SRAE (Safety Residual Aromatic Extract) oils, mineral oils, vegetable oils, ether plasticizers, ester plasticizers, phosphate plasticizers, sulfonate plasticizers, and mixtures of these compounds, are particularly suitable for use. The plasticizing oil that is liquid at 20° C. is preferably selected from the group consisting of paraffinic oils, MES (Medium Extracted Solvate) oils, TDAE (Treated Distillate Aromatic Extract) oils, vegetable oils and mixtures of these, preferably from paraffinic oils.

The composition of the circumferential reinforcing element 52 may optionally also comprise all or some of the usual additives conventionally used in elastomer compositions for tyres, such as pigments, protective agents such as antiozone waxes, chemical antiozonants, antioxidants and antifatigue agents.

The rubber compositions that can be used in the context of the present invention can be manufactured in suitable mixers using two successive preparation phases well known to those skilled in the art:
a first phase of thermomechanical working or kneading (known as the “non-productive” phase), that can be performed in a single thermomechanical step during which all the necessary constituents, notably the elastomeric matrix, the reinforcing filler and the various other optional additives, with the exception of the crosslinking system, are introduced into a suitable mixer, such as a standard internal mixer (for example of the Banbury type). The optional filler may be incorporated in the elastomer in one or more portions, with thermomechanical kneading. If the filler is already incorporated, totally or partially, in the elastomer in the form of a masterbatch, as is described, for example, in the applications WO 97/36724 or WO 99/16600, it is the masterbatch which is directly kneaded and, where appropriate, the other elastomers or fillers present in the composition which are not in masterbatch form, and also the various other optional additives, with the exception of the crosslinking system, are incorporated. The non-productive phase may be performed at high temperature, up to a maximum temperature of between 110° C. and 200° C., preferably between 130° C. and 185° C., for a period of time generally of between 2 and 10 minutes.
a second phase of mechanical working (known as the “productive” phase), which is performed in an external mixer, such as an open mill, after cooling the mixture obtained during the first non-productive phase down to a lower temperature, typically below 120° C., for example between 40° C. and 100° C. The crosslinking system is then incorporated and the combined mixture is then mixed for a few minutes, for example between 5 and 15 min.

Such phases have been described, for example, in the applications EP-A-0501227, EP-A-0735088, EP-A-0810258, WO 00/05300 and WO 00/05301.

The final composition thus obtained is then extruded or co-extruded with another rubber composition in the form of a semi-finished product (or profiled element) of rubber that can be used, for example, as circumferential reinforcing elements or, if it is coextruded, as a tread, for example. These products may then be used for the manufacture of tyres, according to the techniques known to those skilled in the art.

The composition may be either in the green state (before crosslinking or vulcanization) or in the cured state (after crosslinking or vulcanization), or may be a semi-finished product which can be used in a tyre. The composition may be crosslinked in a manner known to those skilled in the art, for example at a temperature of between 130° C. and 200° C., under pressure within the tyre.

The invention relates more particularly to tyres intended to equip motor vehicles having four or more wheels (passenger vehicle, notably of the sports type, or SUV (“Sports Utility Vehicle” for short) type), or else to equip two-wheeled vehicles (notably motorcycles) or else aircraft, industrial vehicles selected from trucks, “heavy-duty” vehicles (that is to say underground trains, buses, heavy road transport vehicles-lorries, tractors and trailers-, or off-road vehicles, such as agricultural or construction plant vehicles), or other transporting or handling vehicles. The invention may equally well be applied to inflated assemblies referred to as “pneumatic tyres” or to non-pneumatic tyre assemblies.

### IV—PREFERRED EMBODIMENTS

In the light of the foregoing, the preferred embodiments of the invention are described below:
1. Tyre (1), having an outer side (E) and an inner side (I), said tyre comprising a crown reinforcement (6) and a radially outer tread (5), said tread (5) comprising a plurality of tread pattern blocks (51) oriented at least partially circumferentially and a plurality of grooves (71, 72, 73, 74) extending at least partially circumferentially, each circumferential groove (71, 72, 73, 74) being delimited by an axially internal lateral face (7i), by an axially external lateral face (7e), and by a groove bottom (7b), at least one of said tread pattern blocks (51) having at least one circumferential reinforcing element (52) made of a composition having a dynamic shear modulus G* at least twice the dynamic shear modulus G* of the composition of the rest of the blocks of the tread, the circumferential reinforcing element (52) having an axial width which decreases progressively within increasing radial proximity to the outside, said axial width having a maximum value (520) of less than 40% of the axial width (510) of said tread block, characterized in that the composition of said circumferential reinforcing element (52) is based on at least one diene elastomer, one reinforcing filler comprising a carbon black exhibiting an STSA specific surface area, measured according to the standard D6556-2016, of greater than or equal to 90 m²/g, one epoxy resin, one amine-comprising curing agent and one crosslinking system.
2. Tyre according to embodiment 1, wherein said axial width of said circumferential reinforcing element (52) has a maximum value (520) less than 30% of the axial width (510) of said block.
3. Tyre according to either one of the preceding embodiments, wherein said circumferential reinforcing element (52) extends radially over a height “h” corresponding to 50% to 100%, preferably 50% to 75%, of the thickness “p” of the tread.
4. Tyre according to any one of the preceding embodiments, wherein said circumferential reinforcing element (52) at least partially forms the axially internal lateral face (7i) or the axially external lateral face (7e) of said at least one of said tread pattern blocks (51).
5. Tyre according to any one of embodiments 1 to 3, wherein axially between said circumferential reinforcing element (52) and the adjacent axially internal lateral face (7i), and radially progressing from the inside towards the outside, at least between a radial level situated above the wear limit by a value representing 5% of the thickness “p” of the tread, and the radial end of the circumferential reinforcing element (52) there is a covering (51a), made of the same composition as the rest of the tread blocks (51) of the tread, over an axial width “A” comprised between 4% and 15% of the axial width (510) of said tread block.
6. Tyre according to any one of the preceding embodiments, wherein the tread has a radially inner layer (8) interposed between the crown reinforcement (6) and said tread blocks (51).
7 Tyre according to any one of the preceding embodiments, wherein the radially inner surface of the circumferential reinforcing element (52) is situated within said tread (5).
8. Tyre according to any one of embodiments 1 to 6, wherein the radially inner surface of the circumferential reinforcing element (52) is in contact with the radially outer surface of said crown reinforcement (6).
9. Tyre according to any one of the preceding embodiments, comprising an extended base (610) extending axially from the circumferential reinforcing element (52).
10. Tyre according to embodiment 9, wherein the extended base (610) is made of the same material as the material of the circumferential reinforcing element (52).
11. Tyre according to embodiment 9 or 10 when they depend on embodiments 1 to 8, comprising at least two circumferential reinforcing elements (52), and wherein the extended base (610) is placed radially on a radially inner layer (8) of the tread that is interposed between the crown reinforcement (6) and said tread blocks (51), and axially covering the radially inner layer (8) of the tread between two circumferential reinforcing elements (52), preferably outside the grooves (71, 72, 73, 74).
12. Tyre according to any one of embodiments 9 to 11 when they depend on embodiments 1 to 8, wherein the extended base (610) is also placed radially on a radially inner layer (8) of the tread that is interposed between the crown reinforcement (6) and said tread blocks (51), and axially covering the radially inner layer (8) of the tread between a circumferential reinforcing element (52) and the shoulder (2).
13. Tyre according to any one of the preceding embodiments, wherein the angle (a) formed by the section of the two lateral walls of the one or more circumferential reinforcing elements (52) in the meridian plane is between 10 and 50 degrees, preferably between 35 and 45 degrees.
14. Tyre according to any one of the preceding embodiments, wherein the circumferential reinforcing element (52) has an axially symmetric shape.
15. Tyre according to any one of the preceding embodiments, wherein the diene elastomer of the composition of said circumferential reinforcing element (52) is selected from the group consisting of polybutadienes, natural rubber, synthetic polyisoprenes, butadiene copolymers, isoprene copolymers and the mixtures of these elastomers.
16. Tyre according to any one of the preceding embodiments, wherein the diene elastomer of the composition of said circumferential reinforcing element (52) is an isoprene elastomer.
17. Tyre according to any one of the preceding embodiments, wherein the diene elastomer of the composition of said circumferential reinforcing element (52) is selected from the group consisting of natural rubber (NR), synthetic polyisoprenes (IRs), the various isoprene copolymers, and the mixtures of these elastomers.
18. Tyre according to any one of the preceding embodiments, wherein the diene elastomer of the composition of said circumferential reinforcing element (52) is selected from the group consisting of natural rubber, synthetic cis-1,4-polyisoprenes and mixtures of these, and more preferentially is natural rubber.
19. Tyre according to any one of the preceding embodiments, wherein the content of diene elastomer in the composition of said circumferential reinforcing element (52) is within a range from 50 to 100 phr, more preferentially from 60 to 100 phr, more preferentially from 70 to 100 phr, more preferentially still from 80 to 100 phr and very preferentially from 90 to 100 phr.
20. Tyre according to any one of the preceding embodiments, wherein the carbon black of the composition of said circumferential reinforcing element (52) exhibits an STSA specific surface area within a range from 95 to 250 m²/g.
21. Tyre according to any one of the preceding embodiments, wherein the carbon black of the composition of said circumferential reinforcing element (52) exhibits an STSA specific surface area within a range from 100 to 190 m²/g.
22. Tyre according to any one of the preceding embodiments, wherein the carbon black of the composition of said circumferential reinforcing element (52) exhibits an STSA specific surface area within a range from 110 to 150 m²/g.
23. Tyre according to any one of the preceding embodiments, wherein the carbon black of the composition of said circumferential reinforcing element (52) has a COAN number, measured according to the standard ASTM D3493-2018, of greater than or equal to 75 ml/100 g.
24. Tyre according to any one of the preceding embodiments, wherein the carbon black of the composition of said circumferential reinforcing element (52) exhibits a COAN number within a range from 80 to 140 ml/100 g.
25. Tyre according to any one of the preceding embodiments, wherein the carbon black of the composition of said circumferential reinforcing element (52) exhibits a COAN number within a range from 90 to 130 ml/100 g.
26. Tyre according to any one of the preceding embodiments, wherein the carbon black of the composition of said circumferential reinforcing element (52) exhibits an iodine absorption number, measured according to the standard ASTM D1510-2017, of greater than or equal to 100 g/kg.
27. Tyre according to any one of the preceding embodiments, wherein the carbon black of the composition of said circumferential reinforcing element (52) exhibits an iodine absorption number within a range from 105 to 200 g/kg.
28. Tyre according to any one of the preceding embodiments, wherein the carbon black of the composition of said circumferential reinforcing element (52) exhibits an iodine absorption number within a range from 115 to 170 g/kg.
29. Tyre according to any one of the preceding embodiments, wherein the carbon black of the composition of said circumferential reinforcing element (52) represents more than 50% by weight of the weight of the reinforcing filler.
30. Tyre according to any one of the preceding embodiments, wherein the carbon black of the composition of said circumferential reinforcing element (52) represents more than 70% by weight of the weight of the reinforcing filler.
31 Tyre according to any one of the preceding embodiments, wherein the carbon black of the composition of said circumferential reinforcing element (52) represents more than 90% by weight of the weight of the reinforcing filler.
32. Tyre according to any one of the preceding embodiments, wherein the carbon black of the composition of said circumferential reinforcing element (52) represents more than 100% by weight of the weight of the reinforcing filler.
33. Tyre according to any one of the preceding embodiments, wherein the content of reinforcing filler in the composition of said circumferential reinforcing element (52) is within a range from 20 to 200 phr, preferably from 25 to 150 phr, more preferentially from 30 to 100 phr.
34. Tyre according to any one of the preceding embodiments, wherein the epoxy resin of the composition of said circumferential reinforcing element (52) is selected from the group consisting of aromatic epoxy resins, alicyclic resins, aliphatic epoxy resins, and mixtures of these.
35. Tyre according to any one of the preceding embodiments, wherein the epoxy resin of the composition of said circumferential reinforcing element (52) is an aromatic epoxy resin, preferably an aromatic novolac epoxy resin.
36. Tyre according to any one of the preceding embodiments, wherein the epoxy resin of the composition of said circumferential reinforcing element (52) is an aromatic epoxy resin and is selected from the group consisting of 2,2 bis[4-(glycidyloxy)phenyl]propane, poly[(o-cresyl glycidyl ether)-co-formaldehyde], poly[(phenyl glycidyl ether)-co-formaldehyde], poly[(phenyl glycidyl ether)-co-(hydroxybenzaldehyde glycidyl ether)], and mixtures of these, more preferentially the aromatic epoxy resin is selected from the group consisting of poly[(o-cresyl glycidyl ether)-co-formaldehyde], poly[(phenyl glycidyl ether)-co-formaldehyde], and a mixture of these.
37. Tyre according to any one of the preceding embodiments, wherein the content of amine-comprising curing agent in the composition of said circumferential reinforcing element (52) is within a range from 1 to 15 phr, preferably from 1 to 10, more preferentially still from 2 to 8 phr.
38. Tyre according to any one of the preceding embodiments, wherein the amine-comprising curing agent of the composition of said circumferential reinforcing element (52) is selected from the group consisting of aliphatic polyamines, alicyclic polyamines, aromatic polyamines, and mixtures of these.
39 Tyre according to any one of the preceding embodiments, wherein the amine-comprising curing agent of the composition of said circumferential reinforcing element (52) is an aromatic polyamine comprising at least two primary amine functions situated on at least one aromatic ring with 6 carbon atoms.
40. Tyre according to any one of the preceding embodiments, wherein the amine-comprising curing agent of the composition of said circumferential reinforcing element (52) is selected from the group consisting of m-xylylenediamine, p-xylylenediamine, 1,3-bis(aminomethyl)cyclohexane, 1,8-diaminooctane, 3,3′-diaminobenzidine, 4,4′-methylenebis[2,6-diethylaniline], methylenebis(3-chloro-2,6-diethylaniline), 1-methyl-3,5-diethyl-2,6-diaminobenzene, 3,5-diethyltoluene-2,4-diamine, 2-methyl-4,6-bis(methylthio)-1,3-benzenediamine, 4-methyl-2,6-bis(methylthio)-1,3-benzenediamine, and the mixtures of these compounds.
41. Tyre according to any one of embodiments 1 to 39, wherein the amine-comprising curing agent of the composition of the circumferential reinforcing element (52) is selected is selected from the group consisting of 4,4′-methylenebis[2,6-diethylaniline], methylenebis(3-chloro-2,6-diethylaniline), 1-methyl-3,5-diethyl-2,6-diaminobenzene, 3,5-diethyltoluene-2,4-diamine, 2-methyl-4,6-bis(methylthio)-1,3-benzenediamine, 4-methyl-2,6-bis(methylthio)-1,3-benzenediamine, and the mixtures of these compounds.
42. Tyre according to any one of the preceding embodiments, wherein the composition of said circumferential reinforcing element (52) does not comprise any plasticizing hydrocarbon resin or comprises it to less than 19 phr, preferably less than 15 phr, more preferably still less than 10 phr.
43. Tyre according to any one of the preceding embodiments, wherein the composition of said circumferential reinforcing element (52) does not comprise any plasticizing hydrocarbon resin.
44. Tyre according to any one of the preceding embodiments, wherein the composition of said circumferential reinforcing element (52) does not comprise any plasticizing oil that is liquid at 20° C. or comprises it to less than 33 phr, preferably less than 15 phr.
45. Tyre according to any one of embodiments 1 to 43, wherein the composition of said circumferential reinforcing element (52) comprises from 0 to 25 phr, preferably from 5 to less than 15 phr, of at least one plasticizing oil that is liquid at 20° C.
46. Tyre according to embodiment 44 or 45, wherein the plasticizing oil that is liquid at 20° C. is selected from the group consisting of naphthenic oils, paraffinic oils, MES (Medium Extracted Solvate) oils, TDAE (Treated Distillate Aromatic Extract) oils, RAE (Residual Aromatic Extract) oils, TRAE (Treated Residual Aromatic Extract) oils and SRAE (Safety Residual Aromatic Extract) oils, mineral oils, vegetable oils, ether plasticizers, ester plasticizers, phosphate plasticizers, sulfonate plasticizers and mixtures of these.
47. Tyre according to embodiment 44 or 45, wherein the plasticizing oil that is liquid at 20° C. is selected from the group consisting of paraffinic oils, MES (Medium Extracted Solvate) oils, TDAE (Treated Distillate Aromatic Extract) oils, vegetable oils and mixtures of these, preferably from paraffinic oils.
48. Tyre according to any one of the preceding embodiments, wherein the crosslinking system of the composition of said circumferential reinforcing element (52) is a vulcanization system based on molecular sulfur and/or on a sulfur-donating agent.
49. Tyre according to any one of the preceding embodiments, wherein the composition of the circumferential reinforcing element (52) does not comprise any reinforcing resin.
50. Tyre according to any one of the preceding embodiments, wherein the composition of the rest of the tread has a dynamic shear modulus G*, measured at 60° C. at 10 Hz and under an alternating shear stress of 0.7 MPa, of less than or equal to 1.3 MPa and preferably less than 1.1 MPa.

### V—EXAMPLES

### V-1 Measurements and Tests Used

### Dynamic Properties

The dynamic properties G* and tan(δ) are measured on a viscosity analyser (Metravib VA4000) according to the standard ASTM D5992-96. The response of a sample of vulcanized composition (cylindrical test specimen with a thickness of 2 mm and a cross section of 79 mm²), subjected to a simple alternating sinusoidal shear stress, at a frequency of 10 Hz, under standard temperature conditions (23° C.) according to the standard ASTM D 1349-09, is recorded. A strain amplitude sweep is performed from 0.01% to 10% (outward cycle) and then from 10% to 0.01% (return cycle).

The results exploited are the complex dynamic shear modulus G* and the loss factor tan(δ). The value of the G* at 5% deformation and also the loss factor, denoted tan(δ), are recorded on the outward cycle.

The results for G* at 5% deformation on the outward cycle and for tan(δ) at 23° C. are expressed as performance in base 100, the value 100 being assigned to the control. A result greater than 100 indicates that the composition of the example under consideration is respectively stiffer and has lower hysteresis, which manifests in better stiffness for the application under consideration and improved (lower) rolling resistance, respectively.

### Mooney Viscosity

Use is made of an oscillating consistometer as described in the French standard ISO 289-1 (2015). The Mooney index measurement is performed according to the following principle: the rubber composition in the green state (i.e., before curing) is moulded in a cylindrical chamber heated to 100° C. After preheating for one minute, the rotor rotates within the specimen at 2 rpm and the working torque for maintaining this movement is measured after rotation for 4 minutes. The Mooney index (ML 1+4) is expressed in “Mooney units” (MU, with 1 MU being 0.83 N·m (Newton·metres)).

The Mooney index results are expressed in terms of performance in base 100, i.e. the value 100 is arbitrarily assigned to the control, so as to consecutively compare the Mooney index of the different sample compositions under test (i.e. their processability). The base 100 value of the sample composition under test is calculated according to the operation: (Mooney index value of the control/Mooney index value of the sample)*100. A result greater than 100 indicates improved performance, i.e. the sample composition under consideration shows a reduction in its viscosity, corroborating better processability relative to the control composition.

### Tearability

The tearability strength and deformation are measured on a specimen drawn at 500 mm/minute to cause the specimen to break. The tensile test specimen is composed of a rubber plaque of parallelepipedal shape, with a thickness of 2 mm, a length of 150 mm and a width of 13 mm, the two lateral edges each being covered in the direction of the length with a cylindrical rubber bead (5 mm diameter) for anchoring in the jaws of the tensile testing machine. Three very fine notches between 17 mm long are made using a razor blade, at mid-length and aligned in the lengthwise direction of the specimen, one at each end and one at the centre of the specimen, before starting the test. The force (N/mm) to be exerted in order to obtain breaking is determined and the elongation at break and the breaking stress are measured. The breaking stress (CR) and the elongation at break are descriptors for the cohesion of the material in terms of resistance to cracking. These measurements are taken under the standard conditions of temperature (23±2° C.) and hygrometry (50±5% relative humidity), according to the French standard NF T 40-101 (December 1979).

The results for breaking stress (CR) and elongation at break (AR) are expressed as performance in base 100, the value 100 being assigned to the control. A result greater than 100 for the two descriptors indicates that the composition of the example under consideration exhibits better cohesion of the material, and therefore will be more resistant to cracking.

### V-2 Tests on Rubber Compositions

The object of the examples presented below is to compare the compromise in performance between the stiffness, hysteresis and cohesion of a composition in accordance with the present invention (C1) with three control compositions (T1, T2 and T3).

Control composition T2 differs from composition T1 only in terms of the grade of the carbon black.

Composition C1, in accordance with the invention, differs from control composition T3 only in terms of the grade of carbon black.

Composition C1, in accordance with the invention, differs from control composition T2 only in terms of the chemical nature of the resin.

The contents of the various constituents of the compositions are presented in Table 1 and expressed in phr (parts by weight per hundred parts by weight of elastomer).

TABLE 1

| | T1 | C2 | C3 | C1 |
|---|---|---|---|---|
| Diene elastomer ⁽¹⁾ | 100 | 100 | 100 | 100 |
| ZnO ⁽²⁾ | 3.00 | 3.00 | 3.00 | 3.00 |
| Antioxidant ⁽³⁾ | 2.50 | 2.50 | 2.50 | 2.50 |
| Stearic acid | 2.00 | 2.00 | 2.00 | 2.00 |
| CBS ⁽⁴⁾ | 2.00 | 2.00 | 2.00 | 2.00 |
| Sulfur | 3.00 | 3.00 | 3.00 | 3.00 |
| Curing resin ⁽⁵⁾ | 12.00 | 12.00 | (—) | (—) |
| HMT3H ⁽⁶⁾ | 4.00 | 4.00 | (—) | (—) |
| Curing resin ⁽⁷⁾ | (—) | (—) | 12.00 | 12.00 |
| Curing agent ⁽⁸⁾ | (—) | (—) | 4.00 | 4.00 |
| Carbon black ⁽⁹⁾ | 70.00 | (—) | 70.00 | (—) |
| Carbon black ⁽¹⁰⁾ | (—) | 70.00 | (—) | 70.00 |

⁽¹⁾ Diene elastomer: natural rubber;
⁽²⁾ Zinc oxide of industrial grade from Umicore;
⁽³⁾ N-(1,3-Dimethylbutyl)-N-phenyl-para-phenylenediamine: Santoflex 6-PPD from Flexsys;
⁽⁴⁾ N-Cyclohexyl-2-benzothiazolesulfenamide: Santocure CBS from Flexsys;
⁽⁵⁾ PF hard resin: phenol-formaldehyde resin of the Phénorez type sold under the name Peracit 4536K from Perstorp;
⁽⁶⁾ Hexamethoxymethyltetramine sold by Degussa;
⁽⁷⁾ Curing resin: epoxy novolac resin: poly[(o-cresyl glycidyl ether)-co-formaldehyde] sold under the name Araldite ECN1299 by Huntsman;
⁽⁸⁾ Amine-comprising curing agent: Dimethylthiotoluenediamine sold under the name Ethacure 300 by Albemarle Louvain
⁽⁹⁾ Carbon black of grade ASTM N326 (ASTM D1565-14) sold by Cabot; STSA surface area measured according to the standard ASTM D6556-2016 is 76 m²/g, the COAN number measured according to the standard ASTM D3493-2018 is 68 ml/100 g, and the iodine adsorption number measured according to the standard ASTM D1510-2017 is 82 g/kg.
⁽¹⁰⁾ Carbon black of grade ASTM N115 (ASTM D1565-14) sold by Cabot; STSA surface area measured according to the standard ASTM D6556-2016 is 124 m²/g, the COAN number measured according to the standard ASTM D3493-2018 is 97 ml/100 g, and the iodine adsorption number measured according to the standard ASTM D1510-2017 is 160 g/kg.

### Preparation of the Rubber Compositions:

For the following tests, the rubber compositions are prepared in the following way: the diene elastomer, the carbon black to be tested, the resin to be tested and its curing agent, and after one to two minutes of mixing, the various other ingredients with the exception of the vulcanization system are introduced into an internal mixer which is 70% full by volume and has an initial vessel temperature of about 50° C. . . . Thermomechanical working (non-productive phase) is then performed in one step (total kneading time equal to about 6 min), until a maximum “dropping” temperature of about 165° C. is reached.

The mixture thus obtained is collected and cooled and the vulcanization system (sulfur and accelerators) is then added on an external mixer (homofinisher) at 70° C., the whole being mixed (productive phase) for about 5 to 6 min.

The compositions thus obtained are subsequently calendered in the form of slabs for measurement of their physical or mechanical properties before and after curing.

The rubber compositions are crosslinked (or cured) at 150° C., for 40 min, under pressure. The mechanical properties before curing (Mooney index) and those after curing are presented in Table 2.

TABLE 2

| | T1 | T2 | T3 | C1 |
|---|---|---|---|---|
| Mooney index (ML 1 + 4) in base 100 | 100 | 143 | 100 | 143 |
| Strain at break (DR) in base 100 | 100 | 98 | 100 | 107 |
| Breaking stress (CR) in base 100 | 100 | 102 | 100 | 111 |
| G* at 5% at 23° C. in base 100 | 100 | 144 | 100 | 154 |
| Tan (δ) max at 23° C. in base 100 | 100 | 94 | 100 | 96 |

Control compositions T1, T2 and T3 have a dynamic shear modulus G* of 25, 36 and 22 MPa. Composition C1, which is in accordance with the invention, has a dynamic shear modulus G* of 34 MPa.

The results presented in Table 2 above show that control composition T2 exhibits a significant improvement in the stiffness (G* max at 23° C.) while still preserving good hysteresis properties (tan(δ) max at 23° C.) and green processability, without substantially modifying the cohesion of the compound (DR and CR) in relation to control composition T1. Inventive composition C1 also exhibits a significant improvement in the stiffness in relation to control composition T3 while still preserving good hysteresis properties and green processability. Moreover, it surprisingly exhibits a significant improvement in the cohesion properties. It will also be noted that, in relation to control composition T2, composition C1, which is in accordance with the invention, exhibits an improvement in the compromise in stiffness/hysteresis/cohesion performance of the compound.

### V-3: Test on Rubber Composition

The object of the examples presented below is to compare the compromise in performance between the stiffness, hysteresis and cohesion of a composition in accordance with the present invention (C2, C3, C4) with three control compositions (T4, T5 and T4) having different contents of carbon black.

Compositions C2, C3 and C4, which are in accordance with the invention, differ from the control composition (T4, T5, T6) only in terms of the grade of carbon black used. The contents of the various constituents of the compositions are presented in Table 3 and expressed in phr (parts by weight per hundred parts by weight of elastomer).

TABLE 3

| | T4 | C2 | T5 | C3 | T6 | C4 |
|---|---|---|---|---|---|---|
| Diene elastomer ⁽¹⁾ | 100 | 100 | 100 | 100 | 100 | 100 |
| ZnO ⁽²⁾ | 7.50 | 7.50 | 7.50 | 7.50 | 7.50 | 7.50 |
| Antioxidant ⁽³⁾ | 2.66 | 2.66 | 2.66 | 2.66 | 2.66 | 2.66 |
| Stearic acid | 0.80 | 0.80 | 0.80 | 0.80 | 0.80 | 0.80 |
| CBS ⁽⁴⁾ | 3.20 | 3.20 | 3.20 | 3.20 | 3.20 | 3.20 |
| Sulfur | 3.20 | 3.20 | 3.20 | 3.20 | 3.20 | 3.20 |
| Curing resin ⁽⁷⁾ | 16.00 | 16.00 | 16.00 | 16.00 | 16.00 | 16.00 |
| Curing agent ⁽⁸⁾ | 7.46 | 7.46 | 7.46 | 7.46 | 7.46 | 7.46 |
| Carbon black ⁽¹⁰⁾ | (—) | 50.00 | (—) | 62.50 | (—) | 75.00 |
| Carbon black ⁽¹¹⁾ | 50.00 | (—) | 62.50 | (—) | 75.00 | (—) |

Ingredients 1, 2, 3, 4, 7, 8 and 10 are those used in test V-2.

11. Carbon black of grade ASTM N772 (ASTM D1565-14) sold by Cabot; STSA surface area measured according to the standard ASTM D6556-2016 is 76 m²/g, the COAN number measured according to the standard ASTM D3493-2018 is 68 ml/100 g, and the iodine adsorption number measured according to the standard ASTM D1510-2017 is 82 g/kg.

Compositions T4 to T6 and C2 to C4 are prepared according to the protocol mentioned in section V-2.

The rubber compositions are crosslinked (or cured) at 150° C., for 40 min, under pressure. The mechanical properties after curing are presented in Table 4.

TABLE 4

| | T4 | C2 | T5 | C3 | T6 | C4 |
|---|---|---|---|---|---|---|
| Strain at break (DR) | 100 | 102 | 100 | 106 | 100 | 103 |
| in base 100 | | | | | | |
| Breaking stress (CR) | 100 | 125 | 100 | 115 | 100 | 105 |
| in base 100 | | | | | | |
| G* at 5% at 23° C. | 100 | 360 | 100 | 375 | 100 | 253 |
| in base 100 | | | | | | |
| Tan (δ) max at 23° C. | 100 | 65 | 100 | 71 | 100 | 72 |
| in base 100 | | | | | | |

Compositions T2, T5 and T6 have a dynamic shear modulus G* of 5, 8 and 15 MPa, respectively. Compositions C2, C3 and C4, which are in accordance with the invention, have a dynamic shear modulus G* of 18, 30 and 28 MPa, respectively.

The results presented in Table 4 above show that, even though the hysteresis properties of the inventive compositions are a little worse than those of the respective control compositions, for all the inventive compositions a very significant gain in stiffness properties at low deformation and a significant improvement in the cohesion properties were observed. The compositions in accordance with the invention exhibit an improvement in the compromise in stiffness/hysteresis/cohesion performance of the compound.

1.-15. (canceled)

16. A tire (1), having an outer side (E) and an inner side (I), the tire comprising a crown reinforcement (6) and a radially outer tread (5), the tread (5) comprising a plurality of tread pattern blocks (51) oriented at least partially circumferentially and a plurality of grooves (71, 72, 73, 74) extending at least partially circumferentially, each circumferential groove (71, 72, 73, 74) being delimited by an axially internal lateral face (7i), by an axially external lateral face (7e), and by a groove bottom (7b), at least one of the tread pattern blocks (51) having at least one circumferential reinforcing element (52) made of a composition having a dynamic shear modulus G* at least twice a dynamic shear modulus G* of a composition of a remainder of the tread pattern blocks, the at least one circumferential reinforcing element (52) having an axial width which decreases progressively within increasing radial proximity to an outside, the axial width having a maximum value (520) of less than 40% of an axial width (510) of the tread pattern block,
wherein the composition of the at least one circumferential reinforcing element (52) is based on at least one diene elastomer, one reinforcing filler comprising a carbon black exhibiting an STSA specific surface area, measured according to standard D6556-2016, of greater than or equal to 90 m²/g, one epoxy resin, one amine-comprising curing agent and one crosslinking system.

17. The tire according to claim 16, wherein the at least one circumferential reinforcing element (52) extends radially over a height h corresponding to 50% to 100% of a thickness p of the tread.

18. The tire according to claim 16, wherein the at least one circumferential reinforcing element (52) at least partially forms the axially internal lateral face (7i) or the axially external lateral face (7e) of the at least one of the tread pattern blocks (51).

19. The tire according to claim 16, wherein the at least one diene elastomer is selected from the group consisting of polybutadienes, natural rubber, synthetic polyisoprenes, butadiene copolymers, isoprene copolymers and mixtures thereof.

20. The tire according to claim 16, wherein the carbon black exhibits an STSA specific surface area within a range from 95 to 250 m²/g.

21. The tire according to claim 16, wherein the carbon black exhibits a COAN number, measured according to standard ASTM D3493-2018, of greater than or equal to 75 ml/100 g.

22. The tire according to claim 16, wherein the carbon black exhibits an iodine absorption number, measured according to standard ASTM D1510-2017, of greater than or equal to 100 g/kg.

23. The tire according to claim 16, wherein the carbon black represents more than 50% by weight of a weight of the one reinforcing filler.

24. The tire according to claim 16, wherein a content of the one reinforcing filler is within a range from 20 to 200 phr.

25. The tire according to claim 16, wherein a content of the one epoxy resin is within a range from 1 to 30 phr.

26. The tire according to claim 16, wherein the one epoxy resin is selected from the group consisting of aromatic epoxy resins, alicyclic novolac resins, aliphatic epoxy resins, and mixtures thereof.

27. The tire according to claim 16, wherein the one epoxy resin is an aromatic epoxy resin and is selected from the group consisting of 2,2 bis[4-(glycidyloxy)phenyl]propane, poly[(o-cresyl glycidyl ether)-co-formaldehyde], poly[(phenyl glycidyl ether)-co-formaldehyde], poly[(phenyl glycidyl ether)-co-(hydroxybenzaldehyde glycidyl ether)], and mixtures thereof.

28. The tire according to claim 16, wherein a content of the one amine-comprising curing agent is within a range from 1 to 15 phr.

29. The tire according to claim 16, wherein the one amine-comprising curing agent is selected from the group consisting of aliphatic polyamines, alicyclic polyamines, aromatic polyamines, and mixtures thereof.

30. The tire according to claim 16, wherein the composition of the remainder of the tread pattern blocks has a dynamic shear modulus G*, measured at 60° C. at 10 Hz and under an alternating shear stress of 0.7 MPa, of less than or equal to 1.3 MPa.
